(19) United States
(12) Patent Application Publication
(10) Pub. No.: US 2007/0211955 A1
(43) Pub. Date: Sep. 13, 2007

(54) Perspective correction panning method for wide-angle image

(75) Inventors: Patrick Pan, Taipei (TW); Tatsumi Mitsushita, Taipei (TW); Christine Lin, Taipei (TW); Benjamin Kuo, Taipei (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Taiwan Limited

(21) Appl. No.: 11/715,869

(22) Filed: Mar. 9, 2007

(30) Foreign Application Priority Data
Mar. 10, 2006 (TW) 95108289

(51) Int. Cl. G06K 9/40

(52) U.S. Cl. 382/254

(57) ABSTRACT

The present invention provides a extracting and correcting method for a wide-angle image which can be a still image or a video stream. The method is able to display the extracted image without distortion. The correction method of the present invention is performed to map sections of the image to a plane with respect to their respective viewing angles. The present invention is adapted to progressively move the view angle and repeat the steps of extracting and correcting, thereby producing the panning effect without distortion.

### FIELD OF THE INVENTION

The present invention relates generally to a technique of image processing. More specifically, the present invention relates to a perspective correction e-panning (electronic panning) method for wide-angle images.

### DESCRIPTION OF THE PRIOR ARTS

Wide-angle images have nonstandard resolution (for example, 1800×460), and thus could be difficult to watch on a standard display device (for example, 640×480) without resizing or sacrificing resolution. Conventional e-panning method treats a wide-angel image as regular large resolution image and displays only slices from the image, which is equivalent to zooming at different part of the wide-angle image without any correction process. However, the conventional method produces distorted result because the wide-angle image is actually represented on a cylindrical surface or a spherical surface.

Panning is a technique often applied to monitor cameras. For example, U.S. Pat. No. 6,977,678 describes a motor panning method for viewing in different directions. Such a method requires physical moving parts (i.e., motors), and is thus susceptible to mechanical degradation and incurs higher power consumption (to drive the motors). In addition, the mechanical components also increase the cost and space requirement for a system.

### SUMMARY OF THE INVENTION

In view of the above problems, an object of the present invention is to provide a perspective correction method adapted to display slices of a wide-angle (panoramic) image without distortion. Another object of the present invention is to provide a perspective correction panning method so as to replace a motor. The present invention has achieved the advantageous effects of low cost, small space requirement and low power consumption.

According to one aspect of the present invention, a perspective correction method for wide-angle images comprises: (a) providing a wide-angle image which is a still image or a video stream; (b) determining a viewing position; (c) extracting a slice of the wide-angle image based on said viewing position; and (d) performing a perspective correction process with respect to the extracted slice of the wide-angle image.

According to another aspect of the present invention, a perspective correction panning method for wide-angle images comprises: (a) providing a wide-angle image which is a still image or a video stream; (b) determining a starting position of image extracting; (c) extracting a slice of the wide-angle image based on said starting position; (d) performing a perspective correction process with respect to the extracted slice of the wide-angle image; (e) cropping and displaying said slice of the wide-angle image after correction; and (f) creating a new starting position by adding a small displacement increment to the previous starting position and repeating the above steps of (c), (d) and (e).

### BRIEF DESCRIPTION OF THE DRAWINGS

FIG. 1 is a flow chart of a perspective correction panning method for wide-angle images according to the present invention.

FIG. 2 shows image planes respectively obtained from three shooting directions of a camera.

FIG. 3 is a top view of FIG. 2 wherein a virtual cylindrical surface is shown.

FIGS. 4(A) and 4(B) are illustrative views for the perspective correction according to an embodiment of the present invention.

FIG. 5 shows sliced images from a wide-angle image to simulate panning effect, according to an embodiment of the present invention.

### DETAILED DESCRIPTION OF THE INVENTION

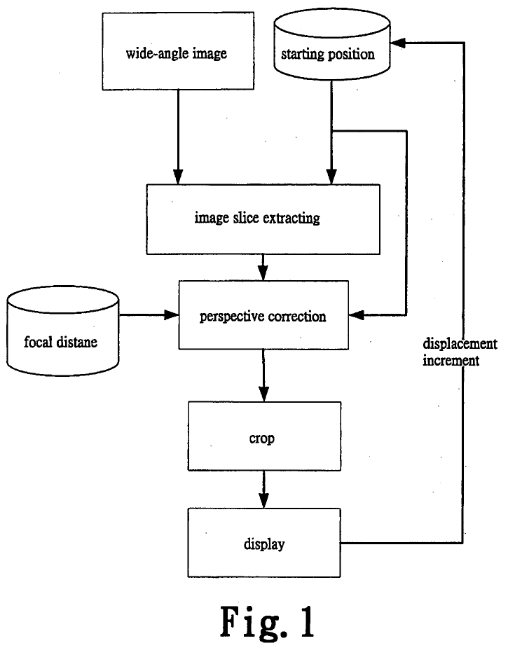

FIG. 1 describes an outline of a perspective correction panning method according to the present invention. This method takes a section of data from a wide-angle image and performs a perspective correction process. Finally, the corrected image is processed and displayed.

As shown in FIG. 1, the wide-angle image is firstly input, wherein said input image can be a single image taken from a wide-angle lens camera system or a stitched image composed of a plurality of small images. In addition, said wide-angle image can be a still image or a video stream. Then, a starting position is input as a starting point for a extracted image of said wide-angle image. Based on said starting position, a slice of said wide-angle image is extracted. With respect to said slice of image, a perspective correction process (discussed later) is performed to create a slice of image without distortion. Said slice of image after perspective correction is cropped to remove the blank area in the image, so that an image after processing is displayed on a display device. Next, a small displacement increment is added to the starting position of the extracted image to form a new starting position, and then the subsequent steps of image extracting, perspective correction, cropping, displaying, etc. are repeated. The above step of adding a small displacement increment has achieved the effect equivalent to the progressive rotation of camera in a conventional panning camera system. Thus a camera system with panning function is successfully simulated without a physical moving part (motor).

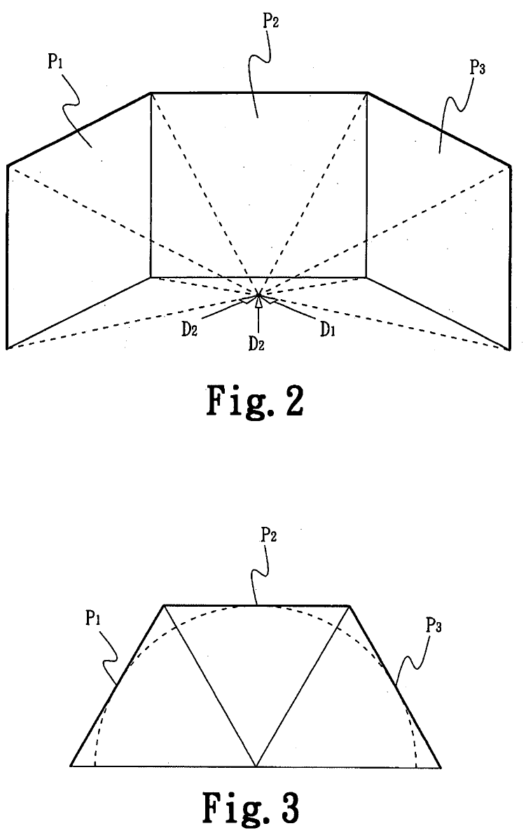

Since a wide-angle image is represented on a cylindrical surface or a spherical surface, a slice of image directly extracted from the wide-angle image is distorted or deformed, especially on both sides of the slice of image. In order to solve the problem of distortion, the inventor has provided a resolution called “perspective correction”. A perspective correction method according to an embodiment of the present invention is described with reference to FIGS. 2 to 5 as follows. For easy understanding of the inventive content, the following description is provided by taking the cylindrical surface as an example.

Firstly, a method of forming a wide-angle image is described with reference to FIG. 2 and FIG. 3. FIG. 2 illustrates three image planes (P1, P2 and P3) taken from three different directions (D1, D2 and D3) respectively by a camera. FIG. 3 is a top view of FIG. 2, wherein the dotted line illustrates a cylindrical surface C. These three image planes (P1, P2 and P3) are mapped onto the cylindrical surface C as a wide-angle image after coordinate transformation, stitching and other processing.

Next, slices of image are extracted from specified positions of the wide-angle image on the cylindrical surface C. The specified positions are directly related to the starting points of image extracting and thus will affect the view angle of the resulting image.

Conventional e-panning methods simply display the above-mentioned slices of image directly on a display device without further processing, which is equivalent to displaying sections of the cylindrical surface C on a planar display device. The objects in the resulting image are inevitably distorted and unable to present normal viewing perspective.

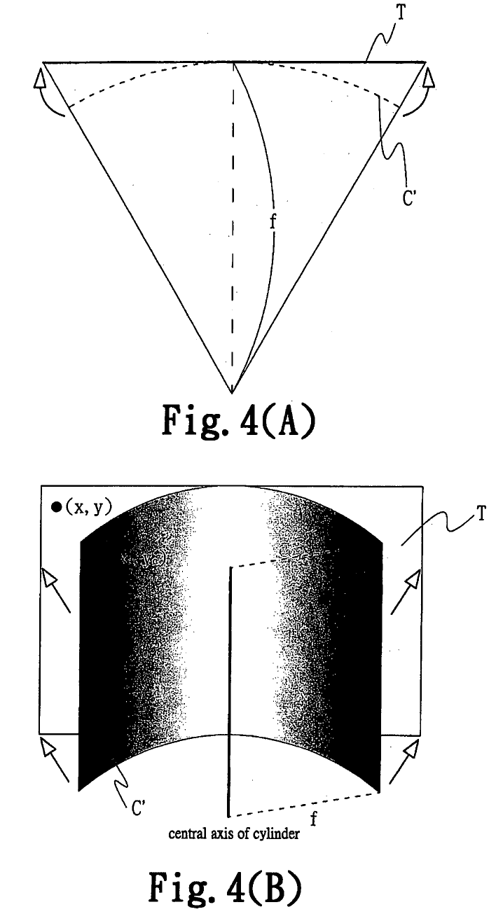

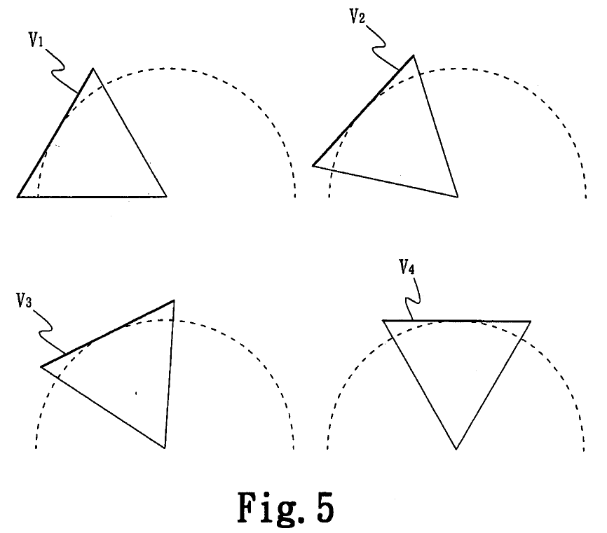

FIGS. 4(A) and 4(B) are planar and perspective views, respectively, for illustrating the perspective correction method according to the present invention. In FIGS. 4(A) and 4(B), C′ denotes a cylindrical section extracted from the cylindrical surface C; T denotes a tangent plane; f denotes the focal distance; (x, y) denotes the coordinate of pixels on the tangent plane T; and (x_{c},y_{c}) denotes the corresponding points on the cylindrical surface. According to an embodiment of the present invention, a reverse transformation is performed to map the image from cylindrical surface C′ to the tangent plane T, as shown by the arrows in FIGS. 4(A) and 4(B), by the following formula:

$${x}_{c} = f * {tan}^{- 1} ( \frac{x}{f} )$$

$${y}_{c} = \frac{f * y}{\sqrt{{x}^{2} + {f}^{2}}}$$

For each integer pixel (x,y), the corresponding (x_{c},y_{c}) will be a fraction (i.e., non-integer). Thus a Bi-linear Interpolation is applied to calculate the image data on (x_{c},y_{c}). In the present embodiment, said image data is the color information of the pixel. With the same formula, it is then possible to map each sections of the image from the cylindrical plane to the tangent plane with respect to their respective viewing angle, which is referred to as “perspective correction”.

FIG. 5 shows four slices of image (V1, V2, V3 and V4) extracted from different angles of a wide-angle image, wherein V1 and V4 are similar to P1 and P2 of FIG. 2, respectively. After the perspective correction, an image cropping process is performed to remove the blank area in the transformed image; a zooming process is performed to obtain a suitable size; and then the processed image can be displayed on a display device.

The above-mentioned steps can be repeated with a small displacement increment added to the starting position of the other extracted image, as the order of V1→V2→V3→V4 shown in FIG. 5. Accordingly, the image obtained by the perspective correction method of the present invention closely resembles the image obtained by a camera system with a panning motor.

### Effects of the Invention

Wide-angle images have unavoidable fish-eye like distortion in nature. Besides, wide-angle images have large resolution and do not fit on the normal display device. For the purpose of viewing, the wide-angle images are typically reduced in resolution or partially displayed. The present invention discloses a method to allow display of slices of images from the wide-angle images in the most natural perspective without distortion. The present invention also allows panning through a wide area without involving a motor in a camera system, and thus results in a more cost-effective and power-saving solution.

1. A perspective correction method for wide-angle images, comprising:
(a) providing a wide-angle image which is a still image or a video stream;
(b) determining a viewing position;
(c) extracting a slice of the wide-angle image based on said viewing position; and
(d) performing a perspective correction process with respect to the extracted slice of the wide-angle image.

2. The perspective correction method of claim 1, wherein said perspective correction process is performed to map the slice of the wide-angle image from a cylindrical surface to a tangent plane, thereby producing an image without distortion.

3. The perspective correction method of claim 1, wherein the extracted slice of the wide-angle image has a display ratio suitable for normal display devices.

4. The perspective correction method of claim 1, further comprising a step of cropping the slice of the wide-angle image for displaying, after the perspective correction process of the above step (d).

5. The perspective correction method of claim 1, wherein the wide-angle image is a stitched image composed of a plurality of images generated by a multi-camera system.

6. The perspective correction method of claim 1, wherein the wide-angle image is a single image taken from a wide-angle lens camera system.

7. A perspective correction panning method for wide-angle images comprises:
(a) providing a wide-angle image which is a still image or a video stream;
(b) determining a starting position of image extracting;
(c) extracting a slice of the wide-angle image based on said starting position;
(d) performing a perspective correction process with respect to the extracted slice of the wide-angle image;
(e) cropping and displaying said slice of the wide-angle image after correction; and
(f) creating a new starting position by adding a small displacement increment to the previous starting position and repeating the above (c), (d) and (e).

8. The perspective correction panning method of claim 7, wherein said perspective correction process is performed to map each slice of the wide-angle image from a cylindrical surface to a tangent plane, thereby producing an image without distortion.

9. The perspective correction panning method of claim 7, wherein the extracted slices of the wide-angle image have a display ratio suitable for normal display devices.

10. The perspective correction panning method of claim 7, wherein the wide-angle image is a stitched image composed of a plurality of images generated by a multi-camera system.

11. The perspective correction panning method of claim 7, wherein the wide-angle image is a single image taken from a wide-angle lens camera system.
